(19) United States
(12) Patent Application Publication
(10) Pub. No.: US 2011/0086741 A1
(43) Pub. Date: Apr. 14, 2011

(54) STACKABLE MOTOR WITH FLEXIBLE MODES OF OPERATION

(75) Inventors: William J. DeFrank, Livonia, MI (US); Seong Jun Kim, Ann Arbor, MI (US); Nam-Huan Thai-Tang, Bloomfield, MI (US); Albert W. Harrison, Detroit, MI (US)

(73) Assignee: ALTe, Auburn Hills, MI (US)

(21) Appl. No.: 12/899,648

(22) Filed: Oct. 7, 2010

Related U.S. Application Data
(60) Provisional application No. 61/250,257, filed on Oct. 9, 2009.

(51) Int. Cl. B60K 6/442; B60W 20/00

(52) U.S. Cl. 477/5; 180/65.23; 180/65.265; 903/902

(57) ABSTRACT

A vehicle comprises a drive sub-system having an engine and a first motor and a generator sub-system having a transmission and a second motor. The transmission for the vehicle is driven with the first motor, the second motor and the engine individually and in combination such that the vehicle may selectively operate in a serial hybrid mode and a parallel hybrid mode.

### CROSS REFERENCE TO RELATED APPLICATIONS

This application claims the benefit of U.S. Provisional Application Ser. No. 61/250,257 filed Oct. 9, 2009, the entire contents of which are hereby incorporated by reference.

### TECHNICAL FIELD

The present invention relates to a hybrid vehicle, and more specifically, to a vehicle that can operate in parallel or series hybrid modes of operation.

### BACKGROUND OF THE INVENTION

Advancements in technology and the growing concern for environmentally efficient vehicles have led to the use of alternate fuel and power sources for vehicles. Electric vehicles or hybrid electric vehicles use electro-mechanical devices (motors) to power the vehicle. In hybrid vehicles the internal combustion engine and the electric motor can be connected in a parallel or series mode of operation. In a series hybrid mode of operation the electric motor drives the vehicle and the internal combustion engine provides additional power to generate the batteries. In the series hybrid mode of operation, the motor needs to have the capacity for all load conditions, including the capacity to meet the maximum torque and power demands of the vehicle. Alternately, in a parallel hybrid mode of operation the engine primarily drives the vehicle and the electric motor provides additional power and assists in starting the vehicle. Both parallel and series hybrid modes of operation provide distinct advantages.

### SUMMARY

A vehicle comprises an internal combustion engine, a transmission and a first and second motor. The first motor is driveably connected to the engine, and the engine and the first motor operate as a generator sub-system for the vehicle. The second motor is driveably connected to the transmission, and the transmission and the second motor operate as a drive sub-system for the vehicle. A first clutch is connected to the first motor to selectively operatively engage the generator sub-system with the drive sub-system.

A method of powering a vehicle comprises operatively connecting a drive sub-system having an engine and a first motor with a generator sub-system having a transmission and a second motor, and driving the transmission with the first motor, the second motor and the engine individually and in combination such that the vehicle may selectively operate in a serial hybrid mode and a parallel hybrid mode.

Another method of powering a vehicle comprises operatively connecting a drive sub-system having an engine and a first motor with a generator sub-system having a transmission and a second motor, and selectively driving the transmission with at least one of the first motor and the second motor such that the vehicle operates in a serial hybrid mode and with at least the engine such that the vehicle operates in a parallel hybrid mode.

The above features and advantages, and other features and advantages of the present invention will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a schematic plan view illustration of a vehicle with a stackable motor having a flexible mode of operation arrangement of the present invention;

FIG. 2 is an exploded schematic perspective illustration of a first embodiment of the stackable motor having the flexible mode of operation arrangement for the electric vehicle of FIG. 1;

FIG. 3 is another schematic illustration of the first embodiment of the stackable motor having the flexible mode of operation arrangement for the electric vehicle of FIGS. 1 and 2;

FIG. 4 is a schematic illustration of a second embodiment of the stackable motor having the flexible mode of operation arrangement for the electric vehicle of FIG. 1;

FIG. 5 is a schematic illustration of a third embodiment of the stackable motor having the flexible mode of operation arrangement for the electric vehicle of FIG. 1; and

FIG. 6 is a schematic illustration of a fourth embodiment of the stackable motor having the flexible mode of operation arrangement for the electric vehicle of FIG. 1.

### DESCRIPTION OF THE PREFERRED EMBODIMENTS

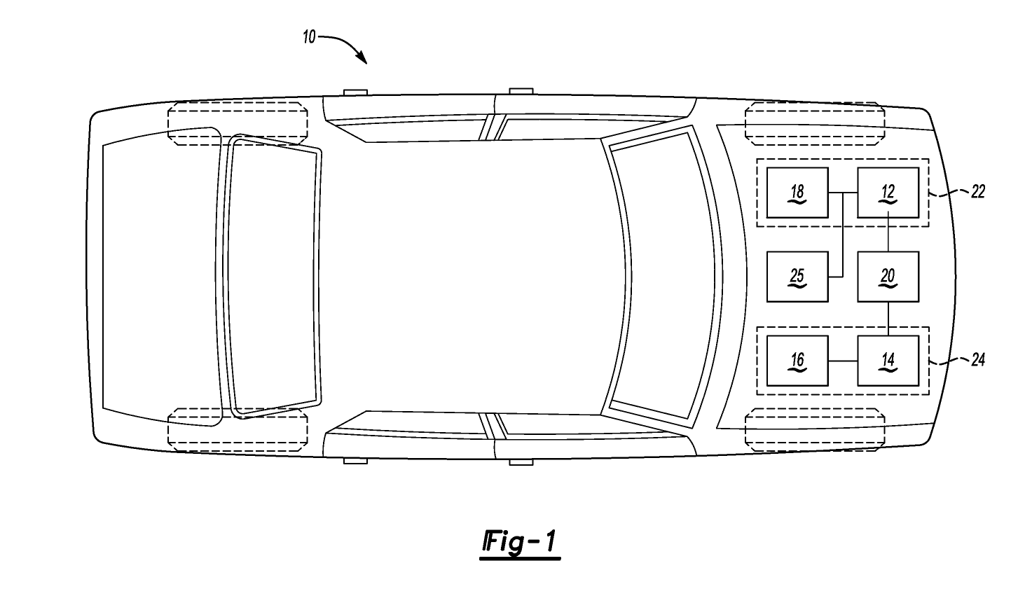

Referring to the Figures, wherein like reference numbers refer to the same or similar components throughout the several views, FIG. 1 schematically illustrates a vehicle 10 including a first motor 12, a second motor 14, and a transmission or gear box 16. In addition to the first motor 12 and the second motor 14 the vehicle 10 also includes an internal combustion engine 18. The engine 18 could be any type of internal combustion engine 18 including but not limited to gasoline, diesel, natural gas (CNG) and liquefied natural gas (LNG).

The first motor 12 and the second motor 14 may be the same size and capacity as one another. The first motor 12 is coupled to the engine 18 and the second motor 14 is coupled to the transmission 16. The first motor 12 and the second motor 14 may be any type of electromechanical device to provide power, such as an induction motor, permanent magnet machine, A/C or D/C motors, etc.

The first motor 12 is coupled to the second motor 14 through a first clutch 20. The first motor 12 and the engine 18 together form a generator sub-system 22. An energy storage system (ESS) 25 is connected to the generator sub-system 22 to store energy for the vehicle 10. The second motor 14 and the transmission 16 together form a drive sub-system 24. The drive sub-system 24 may also include additional motors (not shown) coupled to the second motor 14 to provide additional drive capacity for the vehicle 10. The additional motors (not shown) may be coupled together directly, through clutches or a solid shaft connection, or indirectly, such as by a serpentine belt. Direct coupling of the additional motors to the second motor 14 would provide an efficient arrangement with few losses. Indirect coupling may provide a more flexible arrangement for packaging the second motor 14 and the additional motors within the vehicle 10. One skilled in the art would be able to select the manner of coupling most suited for a particular vehicle 10. Any number of motors may be combined or stacked to provide the capacity required by the vehicle 10. Additionally, the motors may be generally identical to one another in size and capacity.

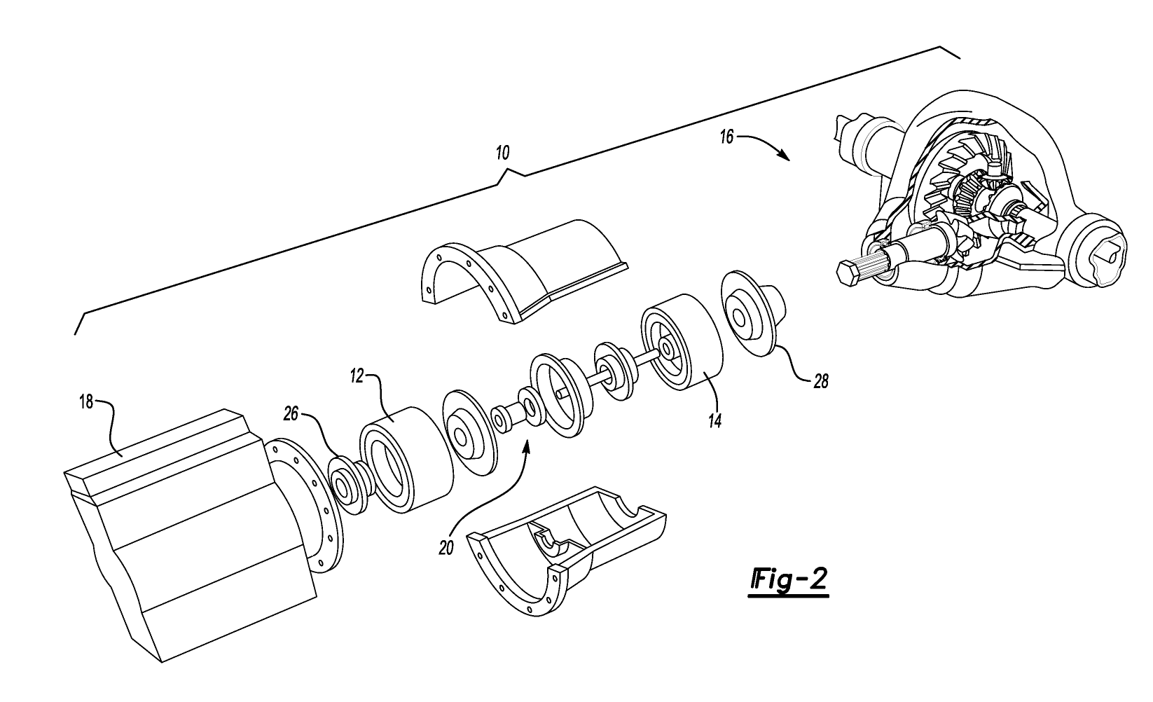

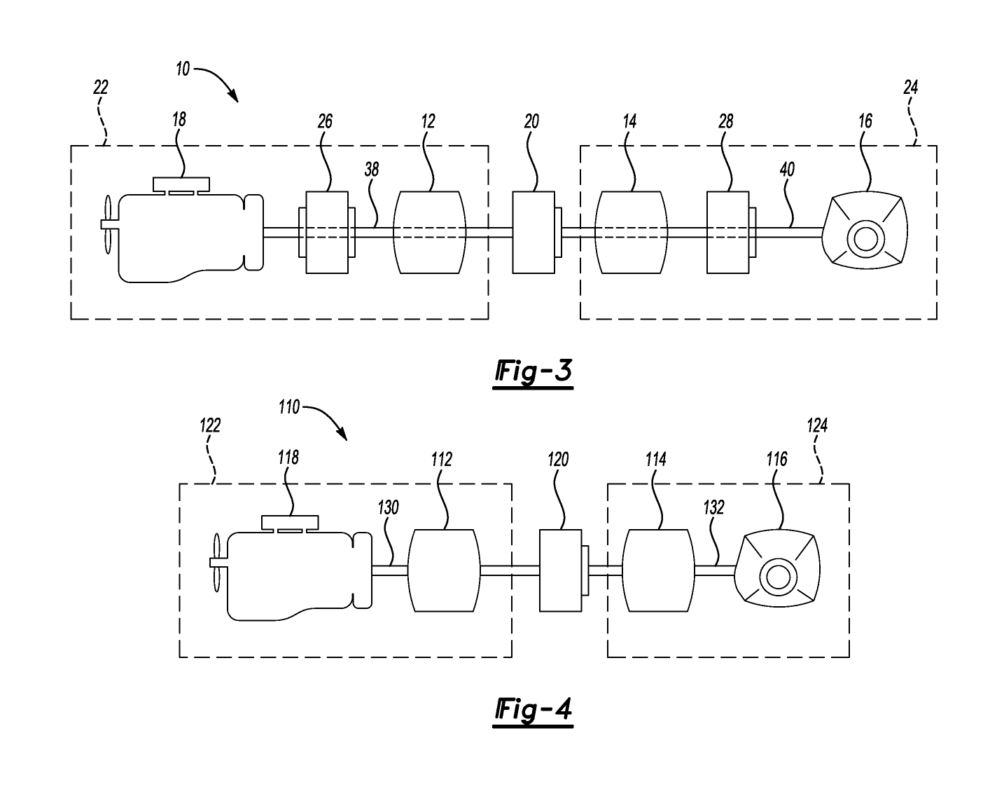

Referring to FIGS. 2 and 3, a first embodiment for the vehicle 10 is further described. The generator sub-system 22 includes the first motor 12 which is coupled to the engine 18 through a second clutch 26. The second clutch 26 is preferably a two-way clutch. Therefore, the first motor 12 may be used to start the engine 18, may act as a generator to provide energy for the ESS 25 (shown in FIG. 1), and may provide drive to the transmission 16, as described below. The drive sub-system 24 includes the second motor 14 which is coupled to the transmission 16 with a third clutch 28. The third clutch 28 is preferably one-way clutch, which allows the second motor 14 to be disengaged from the transmission 16. The first clutch 20, the second clutch 26, and the third clutch 28 may be standard one and two-way clutches.

The first clutch 20 can be disengaged to allow independent operation of the generator sub-system 22 and the drive sub-system 24 from one another. When the generator sub-system 22 and the drive sub-system 24 are decoupled from one another the vehicle 10 is in a series hybrid mode of operation. The engine 18 acts as a generator to recharge the ESS 25 (shown in FIG. 1) for the vehicle 10. The second motor 14 is coupled to the transmission 16 to drive the vehicle 10.

Additionally, the generator sub-system 22 and the drive sub-system 24 may cooperate together to act as a clutch to disengage the appropriate drive device, when the transmission 16 is a manual shift transmission. That is, the generator sub-system 22 and the drive sub-system 24 may be disengaged all of the devices that are driving the transmission 16 for the period of time required to shift gears.

When the first clutch 20 is engaged the generator sub-system 22 and the drive sub-system 24 are coupled together and the vehicle 10 operates in parallel hybrid mode of operation. In the parallel hybrid mode of operation the engine 18 can drive the transmission 16. The first motor 12 and the second motor 14 can be used to assist the engine 18 in driving the transmission 16, as is known for parallel hybrid systems.

Alternatively, while the first clutch 20 is engaged the first motor 12 can be disengaged from the engine 18 and the second motor 14 can be disengaged from the transmission 16 to allow the engine 18 to drive the transmission 16 without driving the first motor 12 and the second motor 14. The generator sub-system 22 components are mounted to be engaged and disengaged from a generator sub-system 24 main shaft 38. Likewise, the drive sub-system 24 components are mounted to be engaged and disengaged from a drive sub-system 24 main shaft 40. Therefore, the engine 18 may be directly connected to the transmission 16, through the generator sub-system main shaft 38 and the drive sub-system main shaft 40, while the first clutch 20 is engaged (to connect the generator sub-system main shaft 38 to the drive sub-system main shaft 40) and the first motor 12 is disengaged from the generator sub-system main shaft 38 and the second motor 14 is disengaged from the drive sub-system main shaft 40. In this arrangement, the vehicle 10 is in an operation mode driven by the engine 18 only. Disengaging the first motor 12 and the second motor 14 reduces the mass driven by the engine 18, and the engine 18 drives just the transmission 16.

While the first clutch 20 is engaged the second clutch 26 may also be engaged to connect the first motor 12 to the engine 18, while the third clutch 28 and, therefore, the second motor 14 are disengaged. This arrangement is another example of a parallel hybrid mode of operation, and allows the first motor 12 to provide additional power to the engine 18, as required. For example, the first clutch 12 may be engaged to connect the first motor 12 to the engine 18 during hard accelerations or while powering the vehicle 10 up a grade.

Alternatively, the vehicle 10 may be operated in parallel hybrid mode of operation with the first clutch 20 engaged, the second clutch 26 disengaged and the third clutch 28 engaged. The second motor 14 is coupled to the transmission 16 and acts as a generator for the ESS 25 (shown in FIG. 1) while the engine 18 drives the transmission 16. The second clutch 26 is disengaged until additional power from the first motor 12 is required as explained above. This would be the standard operating arrangement for the vehicle 10 when in parallel hybrid mode of operation.

In this manner, the first motor 12 and the second motor 14 are stackable to provide the capacity required for the vehicle 10 while primarily operating within the efficiency ranges for the second motor 14. Therefore, one large electric motor may be replaced by multiple smaller motors 12 and 14. Alternatively, the first motor 12 may be engaged prior to reaching the capacity of the second motor 14 and at any time when the second motor 14 begins to operate outside of the desired efficiency range. In this manner the first motor 12 and the second motor 14 may both operate within their efficiency range for greater periods of time and the overall vehicle 10 efficiency will be increased.

Additionally, the first motor 12, the second motor 14, and the engine 18 may act as the primary drive for the vehicle 10 in case of mechanical trouble with any of the first motor 12, second motor 14 or the engine 18. In this instance, the primary drive provided by the first motor 12, the second motor 14, or the engine 18 may not be able to meet the full capacity of the vehicle 10. However, the vehicle 10 would operate in a restricted or limp-home mode but would allow the vehicle 10 operator to reach their destination.

Therefore, as described above, the generator sub-system 22 and the drive sub-system 24 may be coupled in a number of combinations such that the vehicle 10 may operate in serial hybrid mode, parallel hybrid mode, or by internal combustion engine only. One skilled in the art would be able to configure the vehicle 10 to operate in the selected mode as is desirable for a particular combination of vehicle 10 and driving conditions. Additional components may be added to the generator sub-system 22 and/or the drive sub-system 24 to expand the capacity of the vehicle 10. For example, additional motors may be added to the generator sub-system 22 and/or the drive sub-system 24.

FIG. 4 illustrates a second embodiment of the vehicle 110 having a first motor 112 and a second motor 114. The first motor 112 and the second motor 114 may be the same size and capacity as one another. The first motor 112 is coupled to an engine 118 and the second motor 114 is coupled to a transmission 116. The first motor 112 is coupled to the second motor 114 through a first clutch 120. The first motor 112 and the engine 118 together form a generator sub-system 122. The second motor 114 and the transmission 116 together form a drive sub-system 124. The drive sub-system 124 may also include additional motors (not shown) coupled to the second motor 114 to provide additional drive capacity for the vehicle 110. The additional motors (not shown) may be coupled together directly, through clutches or a solid shaft connection, or indirectly, such as a serpentine belt. Direct coupling of the additional motors to the second motor 114 would provide an efficient arrangement with few losses. Indirect coupling may provide a more flexible arrangement for packaging the second motor 114 and within the vehicle 110. One skilled in the art would be able to select the manner of coupling most suited for a particular vehicle 110. Any number of motors may be combined or stacked to provide the capacity required by the vehicle 110. Additionally, the motors may be generally identical to one another in size and capacity.

The generator sub-system 122 includes the first motor 112 which is directly coupled to the engine 118 through a shaft 130 or other solid connection. Therefore, the first motor 112 may be used to start the engine 118 and may also act as a generator to store energy for the vehicle 110. The drive sub-system 124 includes the second motor 114 which is directly coupled to the transmission 116 through a second shaft 132 or other solid connection.

In series hybrid operating mode under standard conditions for the vehicle 110, the first clutch 120 is disengaged to allow independent operation of the generator sub-system 122 and the drive sub-system 124. The engine 118 acts as a generator to recharge the ESS 25 (shown in FIG. 1) for the vehicle 110. The second motor 114 is coupled to the transmission 116 to drive the vehicle 110. When additional power is required the first clutch 120 is engaged to connect the first motor 112 to the second motor 114 and the transmission 116, and the vehicle 110 may operate in parallel hybrid mode. The first motor 112 provides additional power to the transmission 116. For example, the first clutch 120 may be engaged to connect the first motor 112 to the engine 118 during hard accelerations or while powering the vehicle 110 up a grade.

In this manner, the first motor 112 and the second motor 114 are stackable to provide the capacity required for the vehicle 100 while primarily operating within the efficiency ranges for the second motor 114. Therefore, one large electric motor may be replaced by multiple smaller motors 112 and 114. Alternatively, the first motor 112 may be engaged prior to reaching the capacity of the second motor 114 and at any time when the second motor 114 begins to operate outside of the desired efficiency range. In this manner the first motor 112 and the second motor 114 may both operate within their efficiency range for greater periods of time and the overall vehicle 110 efficiency will be increased.

When the first clutch 120 is engaged the engine 118 is also coupled to the transmission 116 and may provide additional power as well as the first motor 112. Therefore, the vehicle 110 may be driven by the second motor 114, the first motor 112 and the engine 118 at the same time.

Additionally, the first motor 112 or the second motor 114 may act as the primary drive for the vehicle 110 in case of mechanical trouble with the first motor 112 or the second motor 114. In this instance, the primary drive provided by the first motor 112 or the second motor 114 may not be able to meet the full capacity of the vehicle 10. However, the vehicle 110 would operate in a restricted or limp-home mode but would allow the vehicle 110 operator to reach their destination.

Therefore, as described above, the generator sub-system 122 and the drive sub-system 124 may be coupled in a number of combinations such that the vehicle 110 may operate in serial hybrid mode or parallel hybrid mode. One skilled in the art would be able to configure the vehicle 110 to operate in the selected mode as is desirable for a particular combination of vehicle 10 and driving conditions.

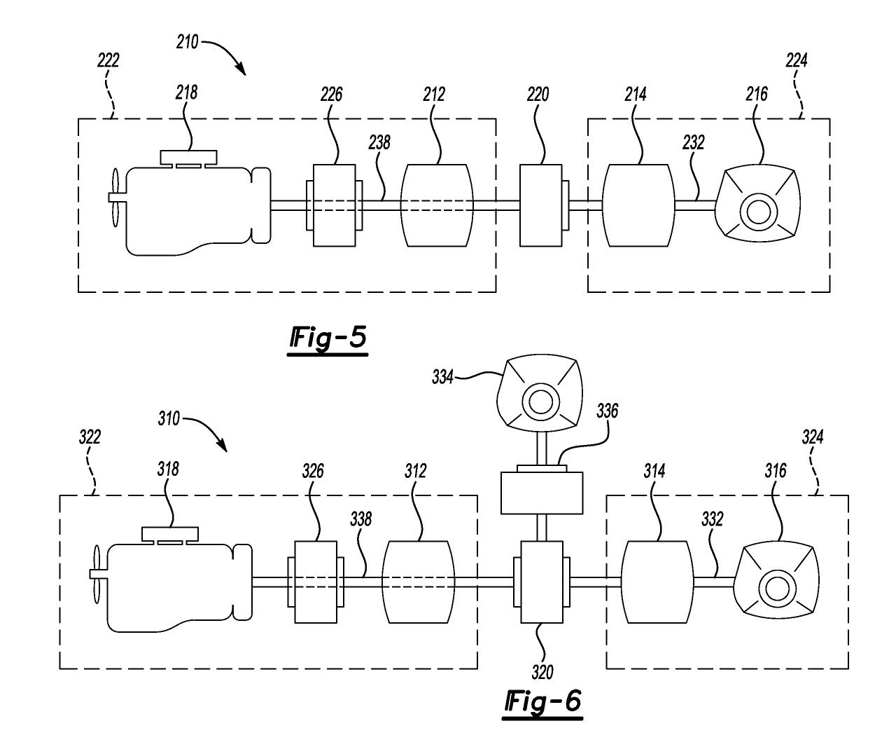

FIG. 5 illustrates a third embodiment of the vehicle 210 having a first motor 212 and a second motor 214. The first motor 212 and the second motor 214 may be the same size and capacity as one another. The first motor 212 is coupled to an engine 218 and the second motor 214 is coupled to a transmission 216. The first motor 212 is coupled to the second motor 214 through a first clutch 220. The first motor 212 and the engine 218 together form a generator sub-system 222. The second motor 214 and the transmission 216 together form a drive sub-system 224. The drive sub-system 224 may also include additional motors (not shown) coupled to the second motor 214 to provide additional drive capacity for the vehicle 210. The additional motors (not shown) may be coupled together directly, through clutches or a solid shaft connection, or indirectly, such as a serpentine belt. Direct coupling of the additional motors to the second motor 214 would provide an efficient arrangement with few losses. Indirect coupling may provide a more flexible arrangement for packaging the second motor 214 and within the vehicle 210. One skilled in the art would be able to select the manner of coupling most suited for a particular vehicle 210. Any number of motors may be combined or stacked to provide the capacity required by the vehicle 210. Additionally, the motors may be generally identical to one another in size and capacity.

The generator sub-system 222 includes the first motor 212 which is coupled to the engine 218 through a second clutch 226. The second clutch 226 is preferably a two-way clutch. Therefore, the first motor 212 may be used to start the engine 218, may act as a generator to store energy for the vehicle 210, and may provide drive for the transmission 216, as described below. The drive sub-system 224 includes the second motor 224, which is directly coupled to the transmission 216 through a second shaft 232 or other solid connection.

In series hybrid operating mode under standard conditions for the vehicle 210 the first clutch 220 is disengaged to allow independent operation of the generator sub-system 222 and the drive sub-system 224. The engine 218 acts as a generator to recharge the ESS 25 (shown in FIG. 1) for the vehicle 210. The second motor 214 is coupled to the transmission 216 to drive the vehicle 210. When additional power is required the first clutch 220 is engaged to connect the first motor 212 to the second motor 214 and the transmission 216, and the vehicle 210 may operate in parallel hybrid mode.

The first motor 212 provides additional power to the transmission 216. For example, the first clutch 220 may be engaged to connect the first motor 212 to the engine 218 during hard accelerations or while powering the vehicle 210 up a grade. The second clutch 226 may be disengaged at this time to allow the first motor 212 to provide additional drive to the transmission 216 without requiring that the first motor 212 also turn the mass of the engine 218.

Additionally, the generator sub-system 222 components are mounted to be engaged and disengaged from a generator sub-system 224 main shaft 238. Therefore, the engine 218 may be connected to the transmission 216, through the generator sub-system main shaft 238, while the first clutch 220 is engaged (to connect the generator sub-system main shaft 238 to the drive sub-system 224) and the first motor 242 may be disengaged from the generator sub-system main shaft 238. In this arrangement the vehicle 210 is in an operation mode driven by the engine 218 and the second motor 214 only. Disengaging the first motor 212 reduces the mass driven by the engine 218.

In this manner, the first motor 212 and the second motor 214 are stackable to provide the capacity required for the vehicle 210 while primarily operating within the efficiency ranges for the second motor 214. Therefore, one large electric motor may be replaced by multiple smaller motors 212 and 214. Alternatively, the first motor 212 may be engaged prior to reaching the capacity of the second motor 214 and at any time when the second motor 214 begins to operate outside of the desired efficiency range. In this manner the first motor 212 and the second motor 214 may both operate within their efficiency range for greater periods of time and the overall vehicle 210 efficiency will be increased.

Alternatively, when the first clutch 220 is engaged the second clutch 226 may also remain engaged and the engine 218 will also be coupled to the transmission 216 and may provide additional power as well as the first motor 212. Therefore, the vehicle 210 may be driven by the second motor 214, the first motor 212 and the engine 218 at the same time.

Additionally, the first motor 212, the second motor 214, and the engine 218 may act as the primary drive for the vehicle 210 in case of mechanical trouble with the first motor 212 or the second motor 214. In this instance, the primary drive provided by the first motor 212, the second motor 214, or the engine 218 may not be able to meet the full capacity of the vehicle 210. However, the vehicle 210 would operate in a restricted or limp-home mode but would allow the vehicle 210 operator to reach their destination.

Therefore, as described above, the generator sub-system 222 and the drive sub-system 224 may be coupled in a number of combinations such that the vehicle 210 may operate in serial hybrid mode or parallel hybrid mode. One skilled in the art would be able to configure the vehicle 210 to operate in the selected mode as is desirable for a particular combination of vehicle 210 and driving conditions.

FIG. 6 illustrates a fourth embodiment of the vehicle 310 having a first motor 312 and a second motor 314. The first motor 312 and the second motor 314 may be the same size and capacity as one another. The first motor 312 is coupled to an engine 318 and the second motor 314 is coupled to a transmission 316. The first motor 312 is coupled to the second motor 314 through a first clutch 320. The first motor 312 and the engine 318 together form a generator sub-system 322. The second motor 314 and the transmission 316 together form a drive sub-system 324. The drive sub-system 324 may also include additional motors (not shown) coupled to the second motor 314 to provide additional drive capacity for the vehicle 310. The additional motors (not shown) may be coupled together directly, through clutches or a solid shaft connection, or indirectly, such as a serpentine belt. Direct coupling of the additional motors to the second motor 314 would provide an efficient arrangement with few losses. Indirect coupling may provide a more flexible arrangement for packaging the second motor 314 and within the vehicle 310. One skilled in the art would be able to select the manner of coupling most suited for a particular vehicle 310. Any number of motors may be combined or stacked to provide the capacity required by the vehicle 310. Additionally, the motors may be generally identical to one another in size and capacity.

The generator sub-system 322 includes the first motor 312 which is coupled to the engine 318 through a second clutch 326. The second clutch 326 is preferably a two-way clutch. Therefore, the first motor 312 may be used to start the engine 318 and may also act as a generator to store energy for the vehicle 310. The drive sub-system 324 includes the second motor 324 which is directly coupled to the transmission 316 through a second shaft 332 or other solid connection.

In series hybrid operating mode under standard conditions for the vehicle 310, the first clutch 320 is disengaged to allow independent operation of the generator sub-system 322 and the drive sub-system 324. The engine 328 acts as a generator to recharge the ESS 25 (shown in FIG. 1), may act as a generator to store energy for the vehicle 310, and may provide drive for the transmission 316, as described below. The second motor 314 is coupled to the transmission 316 to drive the vehicle 310. When additional power is required the first clutch 320 is engaged to connect the first motor 312 to the second motor 314 and the transmission 316, and the vehicle 310 may operate in parallel hybrid mode. The first motor 312 provides additional power to the transmission 316. For example, the first clutch 320 may be engaged to connect the first motor 312 to the engine 318 during hard accelerations or while powering the vehicle 310 up a grade. The second clutch 326 may be disengaged at this time to allow the first motor 312 to provide additional drive to the transmission 316 without requiring that the first motor 312 also turn the mass of the engine 318.

Additionally, the generator sub-system 322 components are mounted to be engaged and disengaged from a generator sub-system 324 main shaft 338. Therefore, the engine 318 may be connected to the transmission 316, through the generator sub-system main shaft 338, while the first clutch 320 is engaged (to connect the generator sub-system main shaft 338 to the drive sub-system 324) and the first motor 342 may be disengaged from the generator sub-system main shaft 338. In this arrangement the vehicle 310 is in an operation mode driven by the engine 318 and the second motor 314 only. Disengaging the first motor 312 reduces the mass driven by the engine 318.

In this manner, the first motor 312 and the second motor 314 are stackable to provide the capacity required for the vehicle 310 while primarily operating within the efficiency ranges for the second motor 314. Therefore, one large electric motor may be replaced by multiple smaller motors 312 and 314. Alternatively, the first motor 312 may be engaged prior to reaching the capacity of the second motor 314 and at any time when the second motor 314 begins to operate outside of the desired efficiency range. In this manner the first motor 312 and the second motor 314 may both operate within their efficiency range for greater periods of time and the overall vehicle 310 efficiency will be increased.

Alternatively, when the first clutch 320 is engaged the second clutch 326 may also remain engaged and the engine 318 will also coupled to the transmission 316 and may provide additional power as well as the first motor 312. Therefore, the vehicle 310 may be driven by the second motor 314, the first motor 312 and the engine 318 at the same time.

Additionally, a second transmission 334 may be coupled to the first clutch 320 through a third or auxiliary clutch 336. The first transmission 316 may be connected to the front wheels (not shown) or the rear wheels (not shown) and the second transmission 334 may be connected to the other of the front wheels (not shown) or the rear wheels (not shown). In serial hybrid mode of operation under standard operating conditions the third clutch 336 is disengaged and the first transmission 316 is driven to drive the vehicle 310.

When four wheel drive mode of operation is required the third clutch 336 may be engaged to couple the second transmission 334 to the drive sub-system 324. When the third clutch 336 is engaged the drive sub-system 324 provides drive to the second transmission 334 and all four wheels of the vehicle 310 are driven. The first clutch 320 is not required to be engaged when the third clutch 336 is engaged to drive the second transmission 334. However, because the second transmission 334 places additional load on the drive sub-system 324 it may be desirable to also engage the first clutch 320 at this time to provide additional power capacity as described above.

Additionally, the first motor 312, the second motor 314, and the engine 318 may act as the primary drive for the vehicle 310 in case of mechanical trouble with the first motor 312 or the second motor 314. In this instance, the primary drive provided by the first motor 312, the second motor 314, or the engine 318 may not be able to meet the full capacity of the vehicle 310. However, the vehicle 310 would operate in a restricted or limp-home mode but would allow the vehicle 310 operator to reach their destination.

Therefore, as described above, the generator sub-system 322 and the drive sub-system 324 may be coupled in a number of combinations such that the vehicle 310 may operate in serial hybrid mode or parallel hybrid mode. One skilled in the art would be able to configure the vehicle 310 to operate in the selected mode as is desirable for a particular combination of vehicle 310 and driving conditions.

While the best modes for carrying out the invention have been described in detail, those familiar with the art to which this invention relates will recognize various alternative designs and embodiments for practicing the invention within the scope of the appended claims.

1. A vehicle comprising:
an internal combustion engine;
a first motor driveably connected to the engine, wherein the engine and the first motor selectively operate as a generator sub-system for the vehicle;
a transmission to drive the vehicle;
a second motor driveably connected to the transmission, wherein the transmission and the second motor selectively operate as a drive sub-system for the vehicle; and
a first clutch connected to the first motor to selectively operatively engage the generator sub-system with the drive sub-system.

2. The vehicle of claim 1, further comprising a second clutch connected to the first motor to selectively operatively engage the first motor with the engine.

3. The vehicle of claim 2, wherein the transmission is driven by one of: the second motor when the first clutch is disengaged; the first motor and the second motor when the first clutch is engaged and the second clutch is disengaged; the engine and the second motor when the first clutch is engaged and the second clutch is disengaged; and the first motor, second motor and the engine when the first clutch and the second clutch are engaged.

4. The vehicle of claim 2, further comprising a third clutch connected to the second motor to selectively operatively engage the second motor with the transmission.

5. The vehicle of claim 4, wherein the transmission is driven by one of: the second motor when the first clutch is disengaged and the third clutch is engaged; the first motor and the second motor when the first clutch and the third clutch are engaged and the second clutch is disengaged; the engine and the second motor when the first clutch and the third clutch are engaged and the second clutch is disengaged; the engine and the first motor when the first clutch and the second clutch are engaged and the third clutch is disengaged; the engine when the first clutch is engaged and the second clutch and third clutch are disengaged; and the first motor, second motor and the engine when the first clutch, the second clutch, and the third clutch are engaged.

5. The vehicle of claim 1, wherein the first motor and the second motor operate in combination with one another when the vehicle is accelerating.

6. The vehicle of claim 1, wherein the first motor and the second motor are operated individually and in combination with one another such that each of the motors primarily operates in a predetermined efficiency range.

7. The vehicle of claim 1, further comprising:
a second transmission, wherein the first transmission drives one of a front wheel set and a rear wheel set of the vehicle and the second transmission drives the other of the front wheel set and the rear wheel set of the vehicle; and
an auxiliary clutch connected to the first clutch to selectively operatively engage the second transmission with the drive sub-system to selectively provide all wheel drive for the vehicle.

8. A method of powering a vehicle comprising:
operatively connecting a drive sub-system having an engine and a first motor with a generator sub-system having a transmission and a second motor; and
driving the transmission with the first motor, the second motor and the engine individually and in combination such that the vehicle may selectively operate in a serial hybrid mode and a parallel hybrid mode.

9. The method of claim 8, wherein driving the transmission comprises driving the transmission with the second motor when a first clutch between the drive sub-system and the generator subsystem is disengaged.

10. The method of claim 9, wherein driving the transmission comprises one of:
driving the transmission with the first motor and the second motor when the first clutch is engaged and a second clutch located between the first motor and the engine is disengaged;
driving the transmission with the engine and the second motor when the first clutch is engaged and the second clutch is disengaged; and
driving the transmission with the first motor, second motor and the engine when the first clutch and the second clutch are engaged.

11. The method of claim 10, wherein driving the transmission comprises one of:
driving the transmission with the second motor when the first clutch is disengaged and the third clutch is engaged;
driving the transmission with the first motor and the second motor when the first clutch and the third clutch are engaged and the second clutch is disengaged;
driving the transmission with the engine and the second motor when the first clutch and the third clutch are engaged and the second clutch is disengaged;
driving the transmission with the engine and the first motor when the first clutch and the second clutch are engaged and the third clutch is disengaged;
driving the transmission with the engine when the first clutch is engaged and the second clutch and third clutch are disengaged; and
driving the transmission with the first motor, second motor and the engine when the first clutch, the second clutch, and the third clutch are engaged.

12. The method of claim 10, further comprising, driving a second transmission with the drive sub-system when an auxiliary clutch is engaged, wherein the first transmission drives one of a front wheel set and a rear wheel set of the vehicle and the second transmission drives the other of the front wheel set and the rear wheel set of the vehicle to selectively provide all wheel drive for the vehicle.

13. A method of powering a vehicle comprising:
operatively connecting a drive sub-system having an engine and a first motor with a generator sub-system having a transmission and a second motor; and
selectively driving the transmission with at least one of the first motor and the second motor such that the vehicle operates in a serial hybrid mode and with at least the engine such that the vehicle operates in a parallel hybrid mode.

14. The method of claim 13, wherein the driving the transmission in serial hybrid mode further comprises:
driving the transmission with the second motor when a first clutch between the drive sub-system and the generator subsystem is disengaged; and
driving the transmission with the first motor and the second motor when the first clutch is engaged and a second clutch located between the first motor and the engine is disengaged.

15. The method of claim 14, wherein the driving the transmission in serial hybrid mode further comprises:
driving the transmission with the second motor when the first clutch is disengaged and a third clutch located between the second motor and the transmission is engaged; and
driving the transmission with the first motor and the second motor when the first clutch and the third clutch are engaged and the second clutch is disengaged.

16. The method of claim 13, wherein driving the transmission in parallel hybrid mode further comprises:
driving the transmission with the engine and the second motor when a first clutch between the drive sub-system and the generator subsystem is engaged and a second clutch located between the first motor and the engine is disengaged; and
driving the transmission with the engine, the first motor, and the second motor when the first clutch is engaged and the second clutch is engaged.

17. The method of claim 16, wherein driving the transmission in parallel hybrid mode further comprises:
driving the transmission with engine and first motor when the first and the second clutch are engaged and a third clutch located between the second motor and the engine is disengaged;
driving the transmission with the engine and the second motor when the first clutch and the third clutch are engaged and the second clutch is disengaged;
driving the transmission with the first motor, the second motor and the engine when the first clutch, the second clutch, and the third clutch are engaged; and
driving the transmission with the engine when the first clutch is engaged and the second clutch and third clutch are disengaged.

18. The method of claim 13, wherein selectively driving the transmission further comprises, driving a second transmission with the drive sub-system when an auxiliary clutch is engaged, wherein the first transmission drives one of a front wheel set and a rear wheel set of the vehicle and the second transmission drives the other of the front wheel set and the rear wheel set of the vehicle to selectively provide all wheel drive for the vehicle.
